(19) United States
(12) Patent Application Publication
(10) Pub. No.: US 2022/0385137 A1
(43) Pub. Date: Dec. 1, 2022

(54) SYSTEM FOR MAGNETIC PISTON

(71) Applicant: Jerome Walter Michael Loach, Richmond, VA (US)

(72) Inventor: Jerome Walter Michael Loach, Richmond, VA (US)

(21) Appl. No.: 17/332,120

(22) Filed: May 27, 2021

(51) Int. Cl. H02K 7/075

(52) U.S. Cl. CPC H02K 7/075

(57) ABSTRACT

The present invention relates to a magnetic piston system that includes: an electromagnetic cap; a magnetized piston; a cylinder which receives the piston and enables free movement of a piston through the cylinder; a series of time pulse rings surrounding the perimeter of the cylinder that enable movement of the piston through the cylinder during use; and a piston rod extending from a cylinder attached at the distal end to a crankshaft.

### FIELD OF INVENTION

The present invention relates to a magnetic piston system that uses an electromagnetically charged piston for power generation.

### BACKGROUND

Mechanical power generation is a common concept that is applied in various applications. One particular application relates to combustible engines that include pistons within a cylinder to engaged with a crankshaft. This particular system is used in various applications but is very common in automobiles and other vehicles. The combustion engine is traditionally powered through petroleum where the piston is forced through a series of movement within a cylinder that rotate the crankshaft. A rod extends from the piston and provides the means for the travel of the piston through the cylinder. This conventional means has been under scrutiny in recent technology in the move toward a more energy favorable system. Such system is envisioned by the present invention through the use of electromagnetic piston within a cylinder that is powered through electromagnetism.

### BRIEF DESCRIPTION OF DRAWINGS

FIG. 1 depicts an electromagnetic piston system according to the present invention.

FIG. 2 depicts the cylinder and piston without the igniting electromagnetic disk.

FIG. 3 shows a timed pulse ring according to the present invention.

### DETAILED DESCRIPTION

The present invention relates to a system for a magnetic piston. The system, according to the present invention, includes a magnetized piston that is mounted on a piston rod connected to a conventional crankshaft. The piston travels through a magnetized cylinder that includes a series of rings that encourage movement of the piston through a cylinder. These time pulse rings ignite pulses of magnetism to encourage movement of the piston through the cylinder. The cylinder movement is initiated through an electromagnetic cap that is mounted on the top of the piston cylinder. Once this electromagnetic cap is charged, it initiates movement of the piston through the cylinder. The piston is charged with the north and south polarity, so the piston moves through the cylinder accordingly. The cylinder includes a series of time pulse rings at a time sequence to control the speed at which the piston moves through the cylinder.

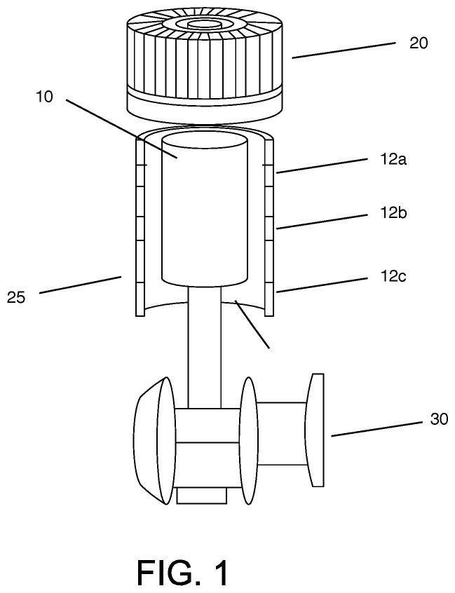

FIG. 1 depicts a system for a magnetic piston according to the present invention. This system includes an electromagnetic Cap 20 on top of a magnetized Cylinder 25. The Cylinder 25 includes Pulse Rings 12(a), 12(b), 12(c), 12(d). These pulse rings control the speed of movement of the Piston 10 through the Cylinder 25. The interior of Cylinder 27 is shown wherein there is some spacing between the piston and the inner cylinder wall. This spacing allows for the free movement of the Piston 10 through the Cylinder 25. A Piston Rod 15 extends from Piston 10 and is attached to a Crankshaft 30 as shown in FIG. 1.

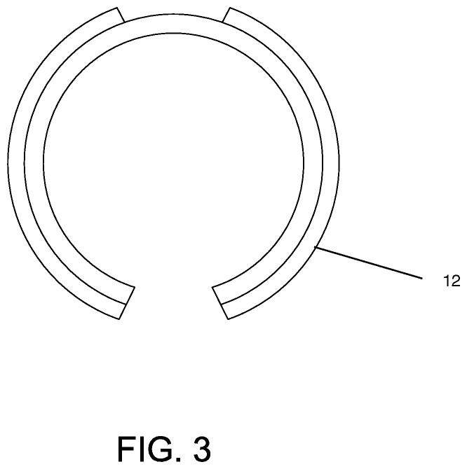

The electromagnetic cap 20 is electronically controlled through initiating movement of the Piston 10 through an initial charge of the cap 20. This initial charge starts the movement of the Piston 10 through the Cylinder 25, and this is further encouraged by the sequencing of time pulse magnetism through the Time Pulse Rings 12. A view of a single time pulse ring 12 is shown in FIG. 3, where this Ring 12 goes around the perimeter of the Cylinder 25.

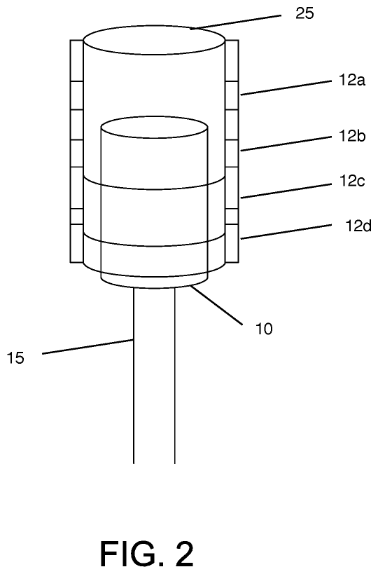

Another view of the Cylinder 25 and Piston 10 is shown in FIG. 2. In this figure, the piston 10 moves through the Cylinder 25 and includes pulsation of the charges to allow for movement of the Piston 10. The rings are time pulsed to coincide with the piston travel to maintain a free movement of piston through the cylinder. Both the electromagnetic Disk 20 and pulse rings are charged electronically from a direct current such as a battery.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. A magnetic piston system comprising:
an electromagnetic cap;
a magnetized piston;
a cylinder which receives the piston and enables free movement of a piston through the cylinder;
a series of time pulse rings surrounding the perimeter of the cylinder that enable movement of the piston through the cylinder during use; and
a piston rod extending from a cylinder attached at the distal end to a crankshaft.
